(19) United States
(12) Patent Application Publication
(10) Pub. No.: US 2024/0194394 A1
(43) Pub. Date: Jun. 13, 2024

(54) COIL COMPONENT

(71) Applicant: SAMSUNG ELECTRO-MECHANICS CO., LTD., Suwon-si (KR)

(72) Inventors: Ye Ji JUNG, Suwon-si (KR); Jae Hun KIM, Suwon-si (KR); Ju Hwan YANG, Suwon-si (KR); In Young KANG, Suwon-si (KR); Boum Seock KIM, Suwon-si (KR)

(73) Assignee: SAMSUNG ELECTRO-MECHANICS CO., LTD., Suwon-si, Gyeonggi-do (KR)

(21) Appl. No.: 18/383,174

(22) Filed: Oct. 24, 2023

(30) Foreign Application Priority Data
Dec. 7, 2022 (KR) 10-2022-0170018

(51) Int. Cl. H01F 27/29; H01F 5/04

(52) U.S. Cl. CPC H01F 27/292; H01F 5/04

(57) ABSTRACT

A coil component includes a body, a support member, a first coil including a first coil portion disposed on one surface of the support member and having one end and the other end being a first lead-out portion and a first connection portion, respectively, a sub-lead-out portion disposed on the other surface of the support member, and a first via connecting the first lead-out portion and the sub-lead-out portion, a second coil disposed on the other surface of the support member and including a second coil portion having one end and the other end being a second lead-out portion and a second connection portion, respectively, and a second via connecting the first and second connection portions, wherein the first via has a diameter greater than a diameter of the second via.

### CROSS-REFERENCE TO RELATED APPLICATION(S)

This application claims benefit of priority to Korean Patent Application No. 10-2022-0170018 filed on Dec. 7, 2022 in the Korean Intellectual Property Office, the disclosure of which is incorporated herein by reference in its entirety.

### TECHNICAL FIELD

The present disclosure relates to a coil component.

Along with the miniaturization and thinning of electronic devices such as digital TVs, mobile phones, laptops, etc., coil components applied to such electronic devices are also required to be miniaturized and thinned. To meet such demands, research and development of various types of winding type or thin film type coil components are being actively conducted.

A major issue due to the miniaturization and thinning of coil components is to implement characteristics equivalent to those of existing coil components despite such miniaturization and thinning. To satisfy these requirements, the proportion of magnetic material in the core filled with magnetic material should be increased, but there is a limit to increasing the ratio, for reasons such as the strength of the inductor body and a change in frequency characteristics due to insulation, and the like.

On the other hand, in the case of a miniaturized thin-film power inductor, a conductive via is included for electrical connection between coil layers. To secure alignment between the conductive via and the coil, a via pad having a larger line width than an end of an innermost turn of the coil pattern may be formed. However, in this case, the size of the core may not be sufficiently secured due to the area of the via pad, and thus, magnetic characteristics of the coil component may be deteriorated.

### SUMMARY

An aspect of the present disclosure is to implement a coil component advantageous for miniaturization by securing a sufficient size of a core and having improved electrical connectivity.

According to an aspect of the present disclosure, a novel structure of a coil component is proposed through an example. The coil component includes a body, a support member disposed within the body, a first coil including a first coil portion disposed on one surface of the support member and having one end and the other end being a first lead-out portion and a first connection portion, respectively, a sub-lead-out portion disposed on the other surface of the support member, and a first via connecting the first lead-out portion and the sub-lead-out portion, a second coil disposed on the other surface of the support member and including a second coil portion having one end and the other end being a second lead-out portion and a second connection portion, respectively, a first external electrode and a second external electrode connected to the first and second coils, respectively, and a second via connecting the first and second connection portions. The first via has a diameter greater than a diameter of the second via.

The first via may be provided as a plurality of first vias.

The plurality of first vias may be arranged in a direction in which the first lead-out portion extends outwardly of the body.

The plurality of first vias may be arranged in a direction, perpendicular to a direction in which the first lead-out portion extends outwardly of the body.

All of the plurality of first vias may have a diameter greater than the diameter of the second via.

Adjacent vias of the plurality of first vias may contact each other.

In the plurality of first vias, adjacent vias may have an overlapping structure.

In the body, first and second recesses accommodating the first and second external electrodes respectively may be disposed.

The sub-lead-out portion may extend into the first recess and may be connected to the first external electrode, and the second lead-out portion may extend into the second recess and may be connected to the second external electrode.

Areas extending from the sub-lead-out portion and the second lead-out to the first and second recesses, respectively, may have thicknesses thinner than thicknesses of other areas.

The coil component may further include a first conductive via connected to the sub-lead-out portion, extending in a thickness direction of the support member, and connected to the first external electrode, and a second conductive via connected to the second lead-out portion, extending in a thickness direction of the support member, and connected to the second external electrode.

The first lead-out portion and the sub-lead-out portion may extend to a first side surface of the body and may be connected to the first external electrode, and the second lead-out portion may extend to a second side surface of the body opposing the first side surface and may be connected to the second external electrode.

According to another aspect of the present disclosure, a coil component includes a body, a support member disposed within the body, a first coil including a first coil portion disposed on one surface of the support member and having one end and the other end being a first lead-out portion and a first connection portion, respectively, a second coil including a second coil portion disposed on an opposite surface of the support member and having one end and the other end being a second lead-out portion and a second connection portion, respectively, a first external electrode and a second external electrode respectively connected to the first and second coils, a sub-lead-out portion disposed on the opposite surface of the support member and connected to the first lead-out portion, a second via connecting the first and second connection portions, and a first via connecting the first lead-out portion and the sub-lead-out portion. The body includes a first recess and a second recess on which the first and second external electrodes are respectively disposed. The sub-lead-out portion extends into the first recess and is connected to the first external electrode. The second lead-out portion extends into the second recess and is connected to the second external electrode. A cross-sectional area of the first via is larger than a cross-sectional area of the second via in a cross-section, perpendicular to a thickness direction of the support member.

A number of the first via may be greater than a number of the second via.
as the body includes a plurality of the first vias.

All of the plurality of first vias may have a diameter greater than a diameter of the second via.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to an embodiment;

FIG. 2 is a view illustrating a cross section taken along line I-I′ in FIG. 1;

FIG. 3 is a view illustrating a cross section taken along line II-II′ of FIG. 1;

FIGS. 4 to 10 are plan views illustrating various types of support members, pad vias, and lead vias; and

FIGS. 11 and 12 illustrate a coil component according to a modified example.

### DETAILED DESCRIPTION

Hereinafter, embodiments will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shape and size of elements in the drawings may be exaggerated for clearer explanation, and elements indicated by the same reference numerals in the drawings are the same elements.

Various types of electronic components are used in electronic devices, and among these electronic components, various types of coil components may be appropriately used for removing noise. For example, in electronic devices, coil components may be used as power inductors, HF inductors, general beads, GHz beads, common mode filters, etc.

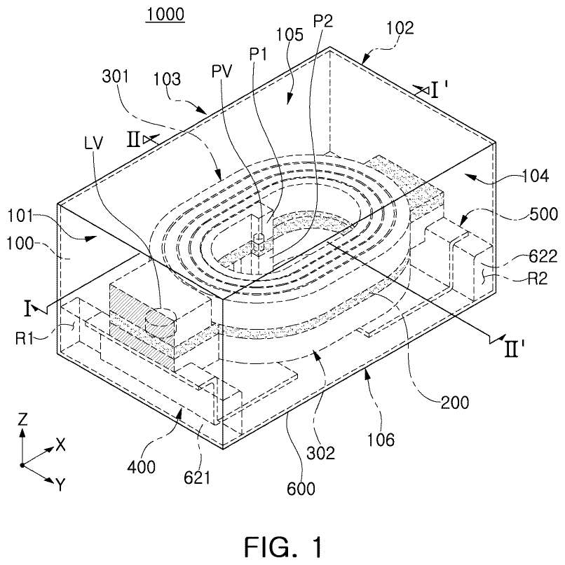

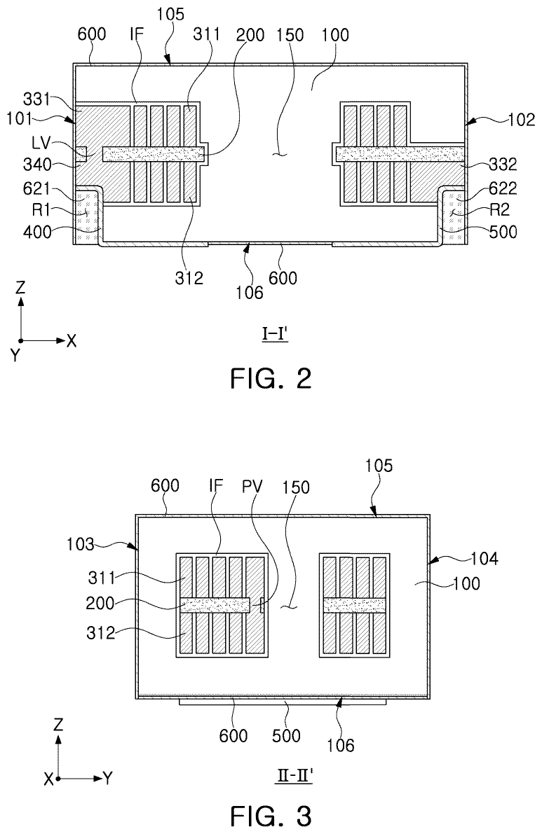

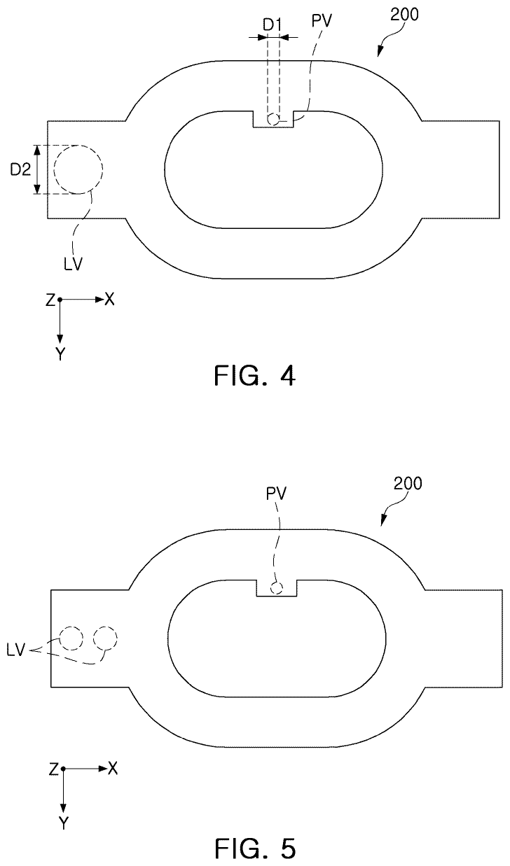

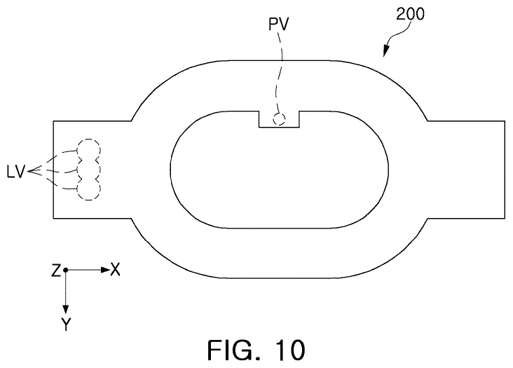

FIG. 1 is a perspective view schematically illustrating a coil component according to an embodiment. FIGS. 2 and 3 are cross-sectional views taken along lines I-I′ and II-II′ of FIG. 1, respectively. FIGS. 4 to 10 are plan views illustrating various types of support members, pad vias, and lead vias.

Referring to FIGS. 1 to 3, a coil component 1000 according to the present embodiment includes a body 100, a support member 200, first and second coils 301 and 302, first and second external electrodes 400 and 500. In this case, in the first coil 301, a first via LV connecting the first lead-out portion 331 and a sub-lead-out portion 340 has a diameter greater than a diameter of a second via PV connecting the first and second connection portions P1 and P2 (D2>D1). In this manner, by making the diameter D1 of the second via PV relatively small and the diameter D2 of the first via LV relatively large, the size of the core 150 may be increased, and electrical connectivity of the first coil 301 is also improved, and thus, open defects and the like may be reduced. Hereinafter, the main elements constituting the coil component 1000 of the present embodiment will be described.

The body 100 forms the exterior of the coil component 1000, and the coils 301 and 302, the support member 200 and the like are disposed therein. As illustrated in the drawings, the body 100 may be formed in the shape of a hexahedron as a whole. The body 100 may include a first surface 101 (first side surface) and a second surface 102 (second side surface) opposing each other in a first direction (X-direction), a third surface 103 and a fourth surface 104 opposing each other in a second direction (Y-direction), and a fifth surface 105 and a sixth surface 106 opposing each other in a third direction (Z-direction). As an example, the body 100 may be formed such that the coil component 1000 according to the present embodiment in which the external electrodes 400 and 500 to be described later are formed has a length of 2.5 mm, a width of 2.0 mm and a thickness of 1.0 mm, or a length of 2.0 mm, a width of 1.2 mm and a thickness of 0.65 mm, or a length of 1.6 mm, a width of 0.8 mm and a thickness of 0.8 mm, or a length of 1.0 mm, a width of 0.5 mm and a thickness of 0.5 mm, or a length of 0.8 mm, a width of 0.4 mm and a thickness of 0.65 mm, but the present disclosure is not limited thereto. On the other hand, since the above-mentioned numerical values are merely design values that do not reflect process errors, or the like, it should be regarded that the range that may be recognized as a process error belongs to the scope of the present disclosure.

The length of the coil component 1000 described above in the first direction (X-direction) may refer to a maximum value among dimensions of the plurality of respective line segments that respective connect the two outermost boundary lines facing each other in the first direction (X-direction) of the coil component 1000 illustrated in the cross-sectional image and are parallel to the first direction (X-direction), based on an optical microscope or scanning electron microscope (SEM) image of a cross-section of the coil component 1000 in the first direction (X-direction)-third direction (Z-direction) at the center of the coil component 1000 in the second direction (Y-direction). Alternatively, the length of the above-described coil component 1000 in the first direction (X-direction) may refer to a minimum value among dimensions of the plurality of respective line segments that respectively connect the two outermost boundary lines facing each other in the first direction (X-direction) of the coil component 1000 illustrated in the cross-sectional image and are parallel to the first direction (X-direction). Alternatively, the length of the above-described coil component 1000 in the first direction (X-direction) may refer to at least three arithmetic average values among dimensions of the plurality of respective line segments that respectively connect the two outermost boundary lines facing each other in the first direction (X-direction) of the coil component 1000 illustrated in the cross-sectional image and are parallel to the first direction (X-direction). In this case, the plurality of line segments parallel to the first direction (X-direction) may be equally spaced from each other in the third direction (Z-direction), but the scope of the present disclosure is not limited thereto.

The length of the coil component 1000 described above, in the second direction (Y-direction), may refer to a maximum value among dimensions of the plurality of respective line segments that respectively connect two outermost boundary lines facing each other in the second direction (Y-direction) of the coil component 1000 illustrated in the cross-sectional image and are parallel to the second direction (Y-direction), based on an optical microscope or scanning electron microscope (SEM) image of a cross-section of the coil component 1000 in the first direction (X-direction)-second direction (Y-direction) at the center of the coil component 1000 in the third direction (Z-direction). Alternatively, this length may refer to a minimum value among dimensions of a plurality of respective line segments that respectively connect two outermost boundary lines facing each other in the second direction (Y-direction) of the coil component 1000 illustrated in the cross-sectional image and are parallel to the second direction (Y-direction). Alternatively, this length may refer to an arithmetic average value of at least three of dimensions of a plurality of respective line segments that respectively connect two outermost boundary lines facing each other in the second direction (Y-direction) of the coil component 1000 illustrated in the cross-sectional image and are parallel to the second direction (Y-direction). In this case, the plurality of line segments parallel to the second direction (Y-direction) may be equally spaced from each other in the first direction (X-direction), but the scope of the present disclosure is not limited thereto.

The length of the coil component 1000 in the third direction (Z-direction) described above may refer to a maximum value among the dimensions of the plurality of respective line segments that respectively connect the two outermost boundary lines facing each other in the third direction (Z-direction) of the coil component 1000 illustrated in the cross-sectional image and are parallel to the third direction (Z-direction), based on an optical microscope or scanning electron microscope (SEM) image of a cross-section of the coil component 1000 in the first direction (X-direction)-third direction (Z-direction) at the center of the coil component 1000 in the second direction (Y-direction). Alternatively, this length may refer to a minimum value among the dimensions of the plurality of respective line segments that respectively connect the two outermost boundary lines facing each other in the third direction (Z-direction) of the coil component 1000 illustrated in the cross-sectional image and are parallel to the third direction (Z-direction). Alternatively, this length may refer to at least three arithmetic average values among the dimensions of the plurality of respective line segments that respectively connect the two outermost boundary lines facing each other in the third direction (Z-direction) of the coil component 1000 illustrated in the cross-sectional image and are parallel to the third direction (Z-direction). In this case, the plurality of line segments parallel to the third direction (Z-direction) may be equally spaced from each other in the first direction (X-direction), but the scope of the present disclosure is not limited thereto.

On the other hand, each of the lengths of the coil component 1000 in the first to third directions may be measured by a micrometer measurement method. The micrometer measurement method may be performed by setting the zero point with a micrometer with Repeatability and Reproducibility (Gage R&R) and inserting the coil component 1000 according to the present embodiment between the tips of the micrometer and by turning the measuring lever of the micrometer. On the other hand, in measuring the length of the coil component 1000 by the micrometer measurement method, the length of the coil component 1000 may refer to a value measured once or may refer to an arithmetic average of values measured a plurality of times.

The body 100 may include an insulating resin and a magnetic material. In detail, the body 100 may be formed by stacking one or more magnetic composite sheets in which a magnetic material is dispersed in an insulating resin. The magnetic material may include ferrite or metallic magnetic powder. The ferrite may include at least one of, for example, spinel ferrites such as Mg—Zn, Mn—Zn, Mn—Mg, Cu—Zn, Mg—Mn—Sr, Ni—Zn, Ba—Zn, Ba—Mg, etc., hexagonal ferrites such as Ba—Ni, Ba—Co, Ba—Ni—Co, etc., Y-type garnet ferrites, or Li-type ferrites. The magnetic metal powder may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may include at least one selected from the group consisting of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder Alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder. The magnetic metal powder may be amorphous or crystalline. For example, the magnetic metal powder may include Fe—Si—B—Cr-based amorphous alloy powder, but is not necessarily limited thereto. Each of the ferrite and magnetic metal powder may have an average diameter of about 0.1 μm to about 30 μm, but the present disclosure is not limited thereto. The body 100 may include two or more types of magnetic materials dispersed in resin. In this case, when the magnetic materials are of different types, it means that the magnetic materials dispersed in the resin are distinguished from each other by at least one of average diameter, composition, crystallinity, or shape. On the other hand, hereinafter, description will be made on the premise that the magnetic material is a magnetic metal powder, but the scope of the present disclosure does not extend only to the body 100 having a structure in which the magnetic metal powder is dispersed in an insulating resin. The insulating resin may include epoxy, polyimide, liquid crystal polymer, etc. alone or in combination, but is not limited thereto.

As illustrated, first and second recesses R1 and R2 in which the first and second external electrodes 400 and 500 are accommodated respectively may be formed in the body 100. In this case, the sub-lead-out portion 340 may extend into the first recess R1 and is connected to the first external electrode 400, and the second lead-out portion 332 may extend into the second recess R2 and be connected to the second external electrode 500. Areas extending from the sub-lead-out portion 340 and the second lead-out portion 332 to the first and second recesses R1 and R2, respectively, may have a thinner thickness than thicknesses of other areas. In addition, the body 100 may include a core 150 penetrating the support member 200 and the coils 301 and 302, and the first and second coil portions 311 and 312 may respectively form at least one turn around the core 150.

The support member 200 is disposed inside of the body 100 and may support the coils 301 and 302. The support member 200 may be formed of an insulating material including a thermosetting insulating resin such as epoxy resin, a thermoplastic insulating resin such as polyimide, or a photosensitive insulating resin, or may be formed of an insulating material impregnated with a reinforcing material such as glass fiber or inorganic filler in the insulating resin. For example, the support member 200 may be formed of an insulating material such as prepreg, Ajinomoto Build-up Film (ABF), FR-4, Bismaleimide Triazine (BT) resin, Photo Imageable Dielectric (PID), etc., but is not limited thereto. The example of the inorganic filler may include at least one selected from the group consisting of silica (silicon dioxide, SiO₂), alumina (aluminum oxide, Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃). When the support member 200 is formed of an insulating material including a reinforcing material, the support member 200 may provide superior rigidity. When the support member 200 is formed of an insulating material that does not contain glass fibers, it may be advantageous to reduce the thickness of the coil component 1000 according to the present embodiment. In addition, the volume occupied by the coils 301 and 302 and/or the magnetic metal powder may be increased based on the body 100 having the same size, and thus, component characteristics may be improved. When the support member 200 is formed of an insulating material including a photosensitive insulating resin, the number of processes for forming the coils 301 and 302 is reduced, which may be advantageous in reducing production costs. The thickness of the support member 200 may be, for example, 10 μm or more and 50 μm or less, but is not limited thereto.

The first coil 301 may include a first coil portion 311, a sub-lead-out portion 340, and a first via (LV), and in this case, one end and the other end of the first coil portion 311 correspond to the first lead-out portion 331 and the first connection portion P1, respectively. The first coil portion 311, the first connection portion P1, and the first lead-out portion 331 may be disposed on one surface (the upper surface based on the drawing in the case of the present embodiment) of the support member 200, and the sub-lead-out portion 340 may be disposed on the other surface (the lower surface based on the drawing) of the support member 200. The first coil portion 311 may include one or more turns around the core 150 and may have a planar spiral shape. However, the present disclosure is not limited thereto, and the first coil portion 311 may also have an angular shape.

The first connection portion P1 may be connected to the second connection portion P2 through the second via PV, and accordingly, the first and second coils 301 and 302 may be connected to each other to function as one coil as a whole. As illustrated, the first connection portion P1 may be formed with a width wider than a width of other regions of the first coil portion 311. However, the first connection portion P1 refers to an area connected to the second via PV, and does not necessarily have to be wider than the line width of other areas of the first coil portion 311. For example, the width of the first connection portion P1 may be the same as the line width of other regions of the first coil portion 311. The first lead-out portion 331 may extend to the first surface 101 of the body 100 and may be covered with an insulating layer 600 to be described later. The first lead-out portion 331 may be connected to the sub-lead-out portion 340 on the other side of the support member 200 through the first via LV.

The sub-lead-out portion 340 may extend to the first surface 101 of the body 100 and the first recess R1, and may be connected to the first external electrode 400. In this embodiment, although the sub-lead-out portion 340 has an asymmetrical structure formed only on the first coil 301, the second coil 301 may also have a sub-draw unit. In the case of an asymmetric structure in which the sub-lead-out portion 340 is formed only on one side of the body 100 as in the present embodiment, the effective volume of the body 100 increases and the inductance characteristics may be improved.

The second coil 302 may be disposed on the other surface of the support member 200 and may include a second coil portion 312 in which one end and the other end are the second lead-out portion 332 and the second connection portion P2, respectively. The second coil portion 312 may include a plurality of turns around the core 150 and may have a planar spiral shape. However, the present disclosure is not limited thereto, and the second coil portion 312 may also have an angular shape. As illustrated, the second connection portion P2 may be formed with a width wider than line widths of other regions of the second coil portion 312. However, the second connection portion P2 refers to an area connected to the second via PV, and does not necessarily be wider than the line width of other areas of the second coil portion 311. For example, the width of the second connection portion P2 may be the same as the line width of other regions of the second coil portion 312. The second lead-out portion 332 may extend to the second surface 102 of the body 100 and may be covered with an insulating layer 600 to be described later.

At least one of the components constituting the first and second coils 301 and 302 may include one or more conductive layers. For example, when the first and second coils 301 and 302 are formed by applying a plating process to the surface of the support member 200, the first and second coils 301 and 302 may each include a first conductive layer formed by electroless plating or the like and a second conductive layer disposed on the first conductive layer. The first conductive layer may be a seed layer for forming the second conductive layer on the support member 200 by plating, and the second conductive layer may be an electroplating layer. In this case, the electroplating layer may have a single-layer structure or a multi-layer structure. The electroplating layer of the multilayer structure may be formed in a conformal film structure in which one electroplating layer is covered by another electroplating layer, and may also be formed in a shape in which another electroplating layer is laminated on only one surface of one electroplating layer. The first and second coils 301 and 302 may include at least one conductive material selected from the group consisting of copper (Cu), aluminum (Al), silver (Ag), tin (Sn), gold (Au), nickel (Ni), lead (Pb), titanium (Ti), alloys thereof, and the like, but are not limited thereto.

An insulating film IF may be formed on surfaces of the first and second coils 301 and 302. The insulating film IF may integrally cover the first and second coils 301 and 302 and the support member 200. In detail, the insulating film IF may be disposed between the first and second coils 301 and 302 and the body 100 and between the support member 200 and the body 100. The insulating film IF may be formed along the surface of the support member 200 on which the first and second coils 301 and 302 are formed, but the present disclosure is not limited thereto. The insulating film IF is for electrically separating the first and second coils 301 and 302 and the body 100, and may include a known insulating material such as parylene, but the present disclosure is not limited thereto. As another example, the insulating film IF may include an insulating material such as an epoxy resin other than parylene. The insulating film IF may be formed by a vapor deposition method, but the formation method thereof is not limited thereto. As another example, the insulating film IF may be formed by laminating and curing an insulating film for forming the insulating film IF on both surfaces of the support member 200 on which the first and second coils 301 and 302 are formed, and may also be formed by applying and curing an insulating paste for forming the insulating film IF on both surfaces of the support member 200 on which the first and second coils 301 and 302 are formed. Meanwhile, for the reasons described above, the insulating film IF is a component that may be omitted in this embodiment. For example, if the body 100 has sufficient electrical resistance at the designed operating current and voltage of the coil component 1000, the insulating film IF may be omitted in this embodiment.

In some embodiments, the diameter D1 of the first via LV is greater than the diameter D2 of the second via PV. As a detailed example, the diameter D1 of the first via LV may be three or more times of the diameter D2 of the second via PV. By reducing the diameter D2 of the second via PV, the sizes of the first and second connection portions P1 and P2 corresponding to innermost turn regions of the first and second coil portions 311 and 312 may be reduced, and therefore, as the size of the core 150 increases, the magnetic properties of the coil component 1000 may be improved. In addition, since the electrical connection between the first lead-out portion 331 and the sub-lead-out portion 340 may be improved by increasing the diameter D1 of the first via LV, an open defect of the coil component 1000 may be reduced. On the other hand, although in the present embodiment, the diameter D1 of the first via LV and the diameter D2 of the second via PV are compared, the comparison may also be performed based on the cross-sectional area of the first and second vias LV and PV. For example, even if the condition of diameter (D1, D2) is not limited, embodiments in which the cross-sectional area of the first via (LV) is larger than the cross-sectional area of the second via (PV) in the cross section perpendicular to the thickness direction (Z direction based on the drawing) of the support member 200 are encompassed by the present disclosure. In this case, the cross-sectional areas of the first and second vias LV and PV may be measured from a cross section including the center of the support member 200 in the thickness direction (Z direction based on the drawing). In addition to this method, the cross-sectional areas of the first and second vias LV and PV may be an average of cross-sectional areas measured on two outermost surfaces in the Z direction, which is the thickness direction of the support member 200. In addition, the diameters D1 and D2 of the first and second vias LV and PV may be measured based on cross-sections, and may be measured in a cross section perpendicular to the thickness direction (Z direction based on the drawing) of the support member 200, in more detail, in a cross section including the center of the support member 200 in the thickness direction. In addition to this method, the diameters D1 and D2 of the first and second vias LV and PV may be an average value of diameters measured on two outermost surfaces in the Z direction, which is the thickness direction of the support member 200. In the case in which the cross-sectional shapes of the first and second vias LV and PV are not circular, the diameters D1 and D2 may be diameters equivalent to a circle converted to a diameter of a circle having the corresponding cross-sectional area. Alternatively, the diameters D1 and D2 of the first and second vias LV and PV may be the average of the lengths in a direction of a longest length of the cross section and lengths in the direction perpendicular thereto.

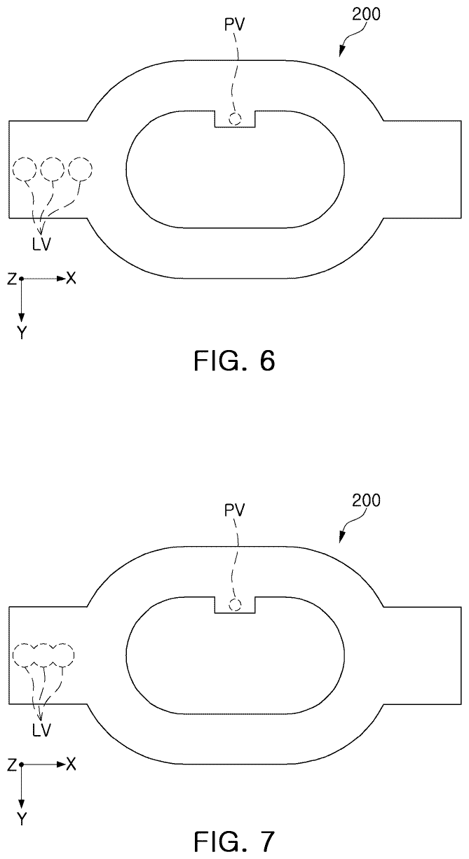

Various forms of the first via LV will be described with reference to FIGS. 4 to 10. First, as in the embodiments of FIGS. 5 and 6, a plurality of first vias LV may be provided. As a detailed example, the number of first vias LV may be greater than the number of second vias PV. FIG. 5 illustrates a case in which there are two first vias LVs, and FIG. 6 illustrates a case in which there are three first vias LVs, and the number of first vias LVs may also be greater than this. In addition, although the present embodiment illustrates a case in which the number of second vias PV is one, the second via PV may also be provided as a plurality of second vias PV, and thus, a more stable connection structure may be implemented. The plurality of first vias LV may be arranged in a direction in which the first lead-out portion 331 extends outward of the body 100, for example, in a lateral direction (X direction) of the body 100. When a plurality of first vias LV are provided, connectivity between the first lead-out portion 331 and the sub-lead-out portion 340 may be improved in structural and electrical aspects. In addition, to further improve the structural and electrical connectivity, all of the plurality of first vias LV may have greater diameters than the second vias PV.

In the case of the embodiment of FIG. 7, in the plurality of first vias LV, the first vias LV adjacent to each other contact each other, and in more detail, may have a structure overlapping with each other. As such, when the plurality of first vias LV contact each other or have a structure overlapping each other, a stable connection structure may be implemented while reducing the overall volume of the first vias LV. In this case, the cross-sectional area of the first vias (LV) of the overlapping structure may be measured from a cross section of the support member 200 including the center in the thickness direction (Z direction relative to the drawing) of the support member 200, and for example, in the image of the cross section, the inner area may be measured after extracting the outer line of the first via LV.

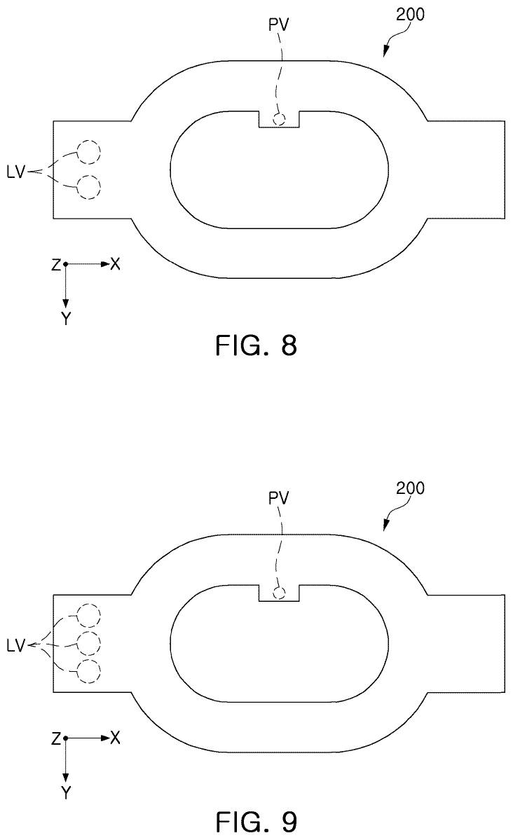

The embodiments of FIGS. 8 to 10 are different from the previous embodiments, in the direction in which the plurality of first vias LV are arranged, and correspond to the embodiments of FIGS. 5 to 7 respectively. As illustrated in FIGS. 8 to 10, the plurality of first vias LV may be arranged in a direction (second direction) perpendicular to the direction in which the first lead-out portion 331 extends outward of the body 100. In the case of arranging the plurality of first vias LV in the second direction (Y-direction), since the plurality of first vias LV may be arranged in a relatively wide area of the first lead-out portion 331, the plurality of first vias LV may have a larger diameter D1.

Other components will be described with reference to FIGS. 1 to 3. The first and second external electrodes 400 and 500 are disposed spaced apart from each other on one surface 106 of the body 100, and may extend into the first and second recesses R1 and R2 and be connected to the sub-lead-out portion 340 and the second lead-out portion 332. In detail, the first external electrode 400 is disposed in the first recess R1 and is contact-connected to the sub-lead-out portion 340 extending into the first recess R1, and may extend to the sixth surface 106 of the body 100. In addition, the second external electrode 500 is disposed in the second recess R2 and connected in contact with the second lead-out portion 332 extending into the second recess R2, and may extend to the sixth surface 106 of the body 100.

The first and second external electrodes 400 and 500 are spaced apart from each other on the sixth surface 106 of the body 100. In addition, the first and second external electrodes 400 and 500 may be formed to protrude further than the insulating layer 600 on the sixth surface 106 of the body 100, but the present disclosure is not limited thereto. When the first and second external electrodes 400 and 500 protrude further than the insulating layer 600 as in the present embodiment, the coil component 1000 may have a relatively wider contact area with the solder or the like, when mounted on a substrate or the like. Thus, the adhesion strength may be strengthened, and the stand-off height (SOH) may also be increased to reduce risk of short circuits.

The first and second external electrodes 400 and 500 are formed along the recesses R1 and R2 and the sixth surface 106 of the body 100, respectively. For example, the external electrodes 400 and 500 are formed in the form of a film conformal to the recesses R1 and R2 and the sixth surface 106 of the body 100. The external electrodes 400 and 500 may be respectively, integrally formed in the recesses R1 and R2 and the sixth surface 106 of the body 100. In this case, the external electrodes 400 and 500 may be formed by a thin film process such as a sputtering process or a plating process.

The first and second external electrodes 400 and 500 may be formed of a conductive material of copper (Cu), aluminum (Al), silver (Ag), tin (Sn), gold (Au), nickel (Ni), lead (Pb), chromium (Cr), titanium (Ti), alloys thereof, or the like, but are not limited thereto. The first and second external electrodes 400 and 500 may be formed in a multi-layer structure. For example, the first layer in which the first and second external electrodes 400 and 500 are connected to the coil 300 may be a conductive resin layer including a conductive powder containing at least one of copper (Cu) and silver (Ag) and an insulating resin, or may be a copper (Cu) plating layer. Also, the second layer may have a double layer structure of a nickel (Ni) plating layer and a tin (Sn) plating layer. The first layer may be formed by electroplating, vapor deposition such as sputtering or the like, or by applying and curing a conductive paste containing conductive powder such as copper (Cu) and/or silver (Ag), and the second layer may be formed by electroplating.

The coil component 1000 according to the present embodiment may further include an insulating layer 600 covering the outer surface of the body 100 and disposed to expose the first and second external electrodes 400 and 500 disposed on the sixth surface 106, for example, the mounting surface. The insulating layer 600 may be, for example, formed by applying and curing an insulating material containing an insulating resin to the surface of the body 100. In this case, the insulating layer 600 may include at least one of thermoplastic resins such as polystyrene, vinyl acetate, polyester, polyethylene, polypropylene, polyamide, rubber, and acrylic, thermosetting resins such as phenol-based, epoxy-based, urethane-based, melamine-based, and alkyd-based resins, and photosensitive insulating resin.

In addition, the coil component 1000 may further include filling portions 621 and 622 disposed between the recesses R1 and R2 and the insulating layer 600. The filling portions 621 and 622 may improve the appearance of the coil component 1000 by filling the corner areas that are depressed due to the formation of the recesses R1 and R2, and may also improve the printing quality of the insulating layer 600. In this embodiment, the first and second filling portions 621 and 622 may be disposed to cover at least portions of the first and second external electrodes 400 and 500, respectively. One surfaces of the filling portions 621 and 622 may be disposed to be substantially coplanar with the first to fourth surfaces 101, 102, 103, and 104 of the body 100. For example, the first filling portion 621 may be disposed substantially coplanar with the first, third, and fourth surfaces 101, 103, and 104 of the body 100, and the second filling portion 622 may be disposed substantially coplanar with the second, third, and fourth surfaces 102, 103, and 104 of the body 100. In this case, being substantially coplanar means being able to share substantially the same plane including errors in the process. The filling portions 621 and 622 may be formed in the recesses R1 and R2 in which the first and second external electrodes 400 and 500 are formed by a method such as a printing method, vapor deposition, spray coating method, or film lamination method, but the present disclosure is not limited thereto. The filling portions 621 and 622 may include a thermoplastic resin such as polystyrene, vinyl acetate, polyester, polyethylene, polypropylene, polyamide, rubber, acrylic, etc., a thermosetting resin such as phenol, epoxy, urethane, melamine, alkyd, etc., a photosensitive resin, parylene, SiOₓ or SiNₓ.

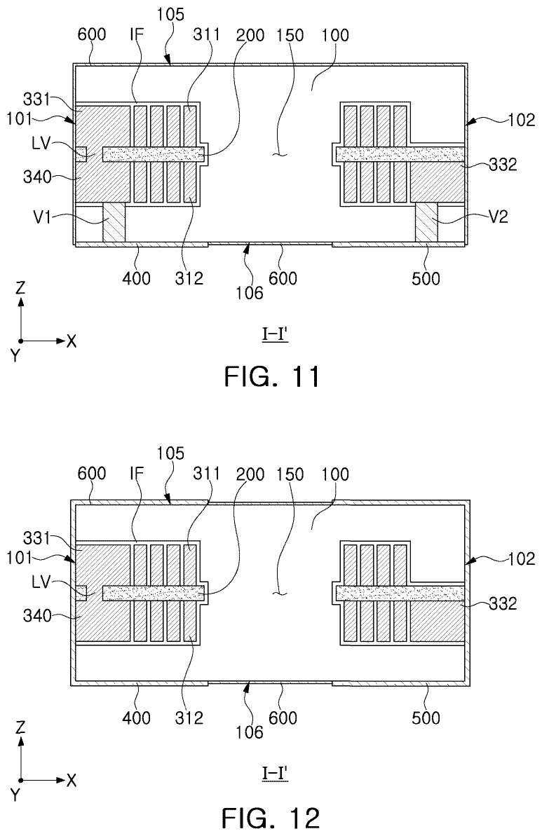

FIGS. 11 and 12 illustrate a coil component according to a modified example, and there is a difference from the above-described embodiment in terms of a connection method between the coils 301 and 302 and the external electrodes 400 and 500 and the shape of the external electrodes 400 and 500. In describing centered on the parts different from the above-described embodiment, first, in the case of the embodiment of FIG. 11, the first coil portion 311 and the first external electrode 400 are connected by a first conductive via V1, and the second coil portion 312 and the second external electrode 500 are connected by a second conductive via V2. For example, the first conductive via V1 is connected to the sub-lead-out portion 340 and extends in the thickness direction (Z direction) of the support member 200 to be connected to the first external electrode 400, and the second conductive via V2 is connected to the second lead-out portion 332 and extends in the thickness direction (Z direction) of the support member 200 to be connected to the second external electrode 500. In the case of this modified example, the process of forming a recess in the body 100 may be omitted, and the magnetic material content of the body 100 may be increased by forming the conductive vias V1 and V2 in relatively small sizes.

Next, in the case of the embodiment of FIG. 12, the first lead-out portion 331 and the sub-lead-out portion 340 extend to the first side surface of the body 100, for example, the first surface 101, and are connected to the first external electrode 400, and the second lead-out portion 332 extends to the second side surface of the body 100 opposing the first side surface, for example, the second surface 102, and is connected to the second external electrode 500. In this case, the first external electrode 400 may extend to the third to sixth surfaces 103 to 106 of the body in addition to the first surface 101 of the body, and similarly, the second external electrode 500 may extend to the third to sixth surfaces 103 to 106 of the body in addition to the second surface 102 of the body.

As set forth above, according to an embodiment, a coil component advantageous for miniaturization and having improved electrical connectivity by securing a sufficient size of the core may be implemented.

While example embodiments have been illustrated and described above, it will be apparent to those skilled in the art that modifications and variations could be made without departing from the scope of the present disclosure as defined by the appended claims.

What is claimed is:

1. A coil component comprising:
a body;
a support member disposed within the body;
a first coil including a first coil portion disposed on one surface of the support member and having one end and the other end being a first lead-out portion and a first connection portion, respectively, a sub-lead-out portion disposed on an opposite surface of the support member, and at least one first via connecting the first lead-out portion and the sub-lead-out portion;
a second coil disposed on an opposite surface of the support member and including a second coil portion having one end and the other end being a second lead-out portion and a second connection portion, respectively;
a first external electrode and a second external electrode connected to the first and second coils, respectively; and
at least one second via connecting the first and second connection portions,
wherein the first via has a diameter greater than a diameter of the second via.

2. The coil component of claim 1, wherein the first coil includes a plurality of the first vias.

3. The coil component of claim 2, wherein the plurality of the first vias are arranged in a direction in which the first lead-out portion extends outwardly of the body.

4. The coil component of claim 2, wherein the plurality of the first vias are arranged in a direction, perpendicular to a direction in which the first lead-out portion extends outwardly of the body.

5. The coil component of claim 2, wherein all of the plurality of the first vias have a diameter greater than the diameter of the second via.

6. The coil component of claim 2, wherein adjacent vias of the plurality of the first vias contact each other.

7. The coil component of claim 6, wherein in the plurality of the first vias, at least two adjacent vias connect with each other.

8. The coil component of claim 1, wherein the body includes first and second recesses on which the first and second external electrodes respectively are disposed.

9. The coil component of claim 8, wherein the sub-lead-out portion extends into the first recess and is connected to the first external electrode, and
the second lead-out portion extends into the second recess and is connected to the second external electrode.

10. The coil component of claim 9, wherein an area extending from the sub-lead-out portion to the first recess has a thickness thinner than a thickness of other areas of the sub-lead-out portion, or
an area extending from the second lead-out portion to the second recess has a thickness thinner than a thickness of other areas of the second lead-out portion.

11. The coil component of claim 1, further comprising:
a first conductive via connected to the sub-lead-out portion, extending in a thickness direction of the support member, and connected to the first external electrode; and
a second conductive via connected to the second lead-out portion, extending in a thickness direction of the support member, and connected to the second external electrode.

12. The coil component of claim 1, wherein the first lead-out portion and the sub-lead-out portion extend to a first side surface of the body and are connected to the first external electrode, and
the second lead-out portion extends to a second side surface of the body opposing the first side surface and is connected to the second external electrode.

13. A coil component comprising:
a body;
a support member disposed within the body;
a first coil including a first coil portion disposed on one surface of the support member and having one end and the other end being a first lead-out portion and a first connection portion, respectively;
a second coil including a second coil portion disposed on an opposite surface of the support member and having one end and the other end being a second lead-out portion and a second connection portion, respectively;
a first external electrode and a second external electrode respectively connected to the first and second coils;
a sub-lead-out portion disposed on the opposite surface of the support member and connected to the first lead-out portion;
at least one second via connecting the first and second connection portions; and
at least one first via connecting the first lead-out portion and the sub-lead-out portion,
wherein the body includes a first recess and a second recess in which the first and second external electrodes are respectively disposed,
the sub-lead-out portion extends into the first recess and is connected to the first external electrode,
the second lead-out portion extends into the second recess and is connected to the second external electrode, and
a cross-sectional area of the first via is larger than a cross-sectional area of the second via in a cross-section perpendicular to a thickness direction of the support member.

14. The coil component of claim 13, wherein a number of the first via is greater than a number of the second via.

15. The coil component of claim 13, wherein the coil component comprises a plurality of the first vias.

16. The coil component of claim 15, wherein all of the plurality of first vias have a diameter greater than a diameter of the second via.
